(19) United States
(12) Patent Application Publication
(10) Pub. No.: US 2023/0302522 A1
(43) Pub. Date: Sep. 28, 2023

(54) UNIVERSAL AUTOMATION TOOLING RECEIVER/ADAPTER ASSEMBLY

(71) Applicant: Mesco Integrated Material Solutions, Flint, MI (US)

(72) Inventors: Daniel Orrell, Emmett, MI (US); Duane Orrell, Livonia, MI (US)

(21) Appl. No.: 18/189,405

(22) Filed: Mar. 24, 2023

Related U.S. Application Data
(60) Provisional application No. 63/323,549, filed on Mar. 25, 2022.
(60) Provisional application No. 63/393,298, filed on Jul. 29, 2022.

(51) Int. Cl. B21D 43/28

(52) U.S. Cl. CPC B21D 43/287

(57) ABSTRACT

A universal automation tooling receiver/adapter assembly includes a receiver with mechanical coding which may include both air and electric control, a steel plate, and two gib supports. An adapter whose style is dependent on the type of tooling required, and a manifold with mechanical coding and which may include air and electric. In use, the receiver/adapter assembly can be used in multiple applications where material is being picked up and moved from a first location to second location and/or to hold parts between operations in a press.

### FIELD OF THE INVENTION

The present invention relates generally to end of arm tooling and idle stations and more particularly to a universal receiver/adapter assembly used with any automation equipment used to move parts from point A to point B or hold parts between operations in a press.

### BACKGROUND

There are many manufacturers and stampers that use end of arm automation tooling to move parts from one location to another. An example of such a part being moved is a hood, fender, or bodyside panel between dies within a press. These parts are large and heavy, and the end of arm automation tooling works to rapidly move the position of the part during the stamping process. Regarding the automotive OEM market, many manufacturers transfer panels between dies in a press line using different types of transfer tooling systems. These types of tooling are called crossbar, tri-axis, or tandem/robot tooling. The devices used to move material range from simple one-person lift-assist devices to highly mechanized transfer systems. As seen in both prior art FIG. 1A and FIG. 1B, a crossbar assembly includes a crossbar 101 used to hold a clamping assembly 103. In use, clamps 103 hold the assembly 100 and any tooling implements 105, used for a specific task, to the crossbar 101.

One problem associated with this type of automation tooling is that the clamping assembly is permanently affixed to the crossbar. When setting up the next job in the press, the entire crossbar must be removed from the press. New solutions are needed to allow each tooling assembly to be removed from the crossbar during job changes, which allow the crossbars to stay in the press and be used for multiple jobs.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A and FIG. 1B are prior art illustrations showing an automation assembly using a crossbar and receiver.

FIG. 2A, FIG. 2B and FIG. 2C are illustrations showing a perspective, assembled and exploded views respectively of an automation tooling receiver/adapter assembly according to an embodiment to the invention.

FIG. 3A and FIG. 3B are illustrations showing various styles of receivers.

FIG. 4A, FIG. 4B, FIG. 4C and FIG. 4D are illustrations showing magnified views of the various styles of tooling adapters used with the receiver/adapter assembly.

FIG. 5A, FIG. 5B and FIG. 5C are illustrations of various styles of straight tooling adapters.

FIG. 6A and FIG. 6B are illustrations of a gib support and steel plate respectively.

FIG. 7A and FIG. 7B are illustrations of various styles of receiver assemblies with no air/electric provision.

FIG. 8 is an illustration of an upper and lower spacer plate for a Verson 120 crossbar.

FIG. 9A and FIG. 9B are illustrations of various adapter manifolds.

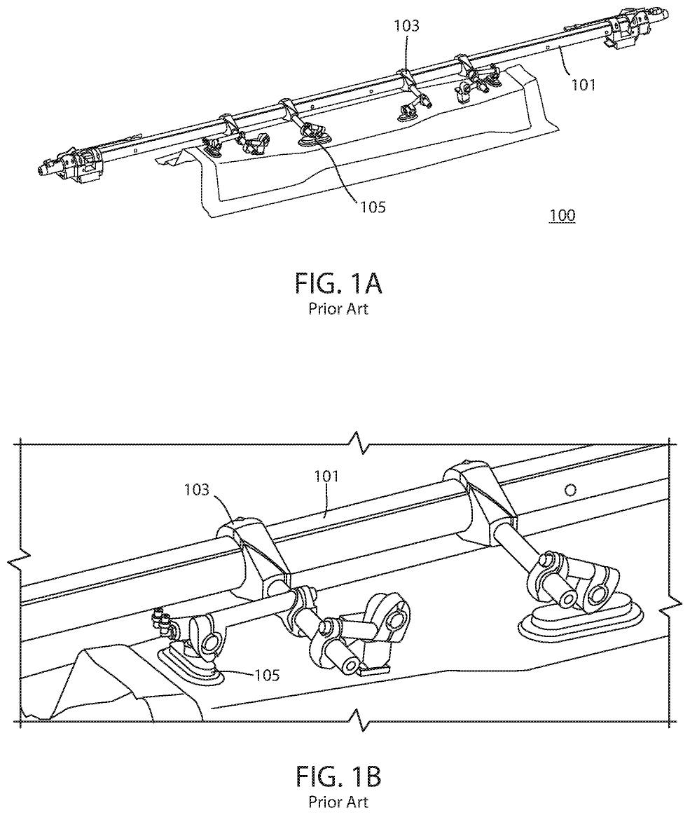

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a universal receiver/adapter assembly. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

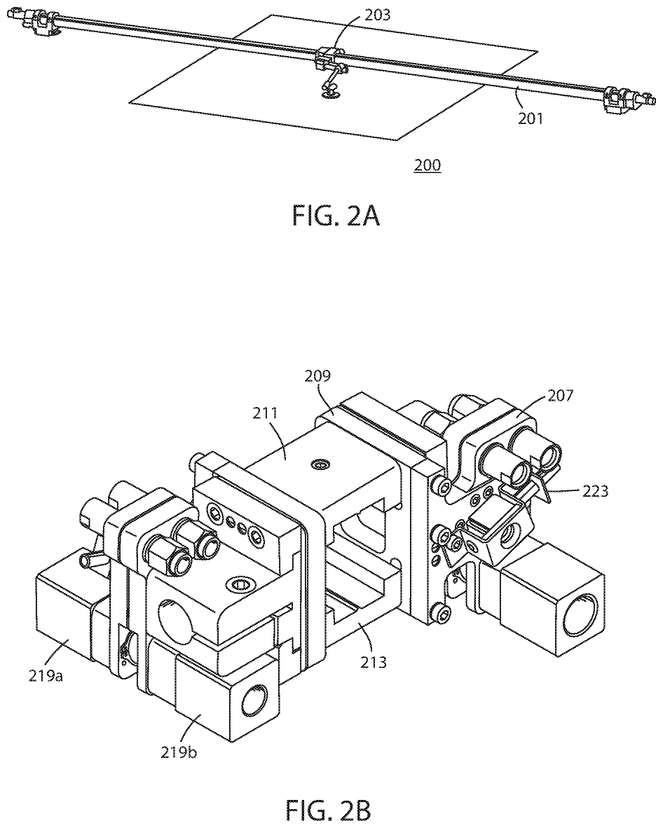

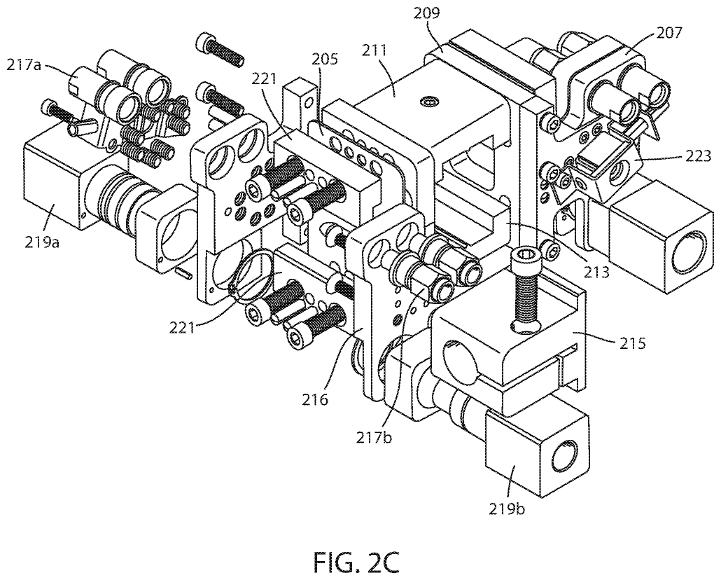

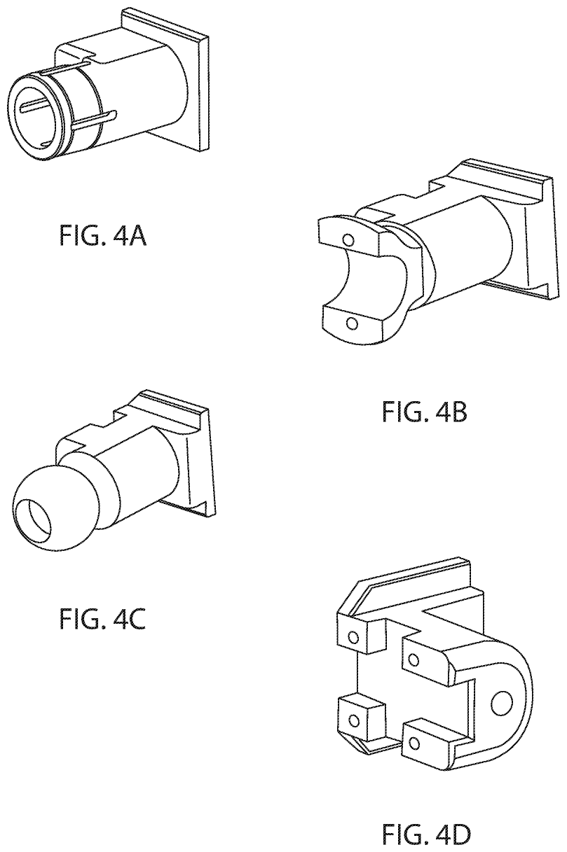

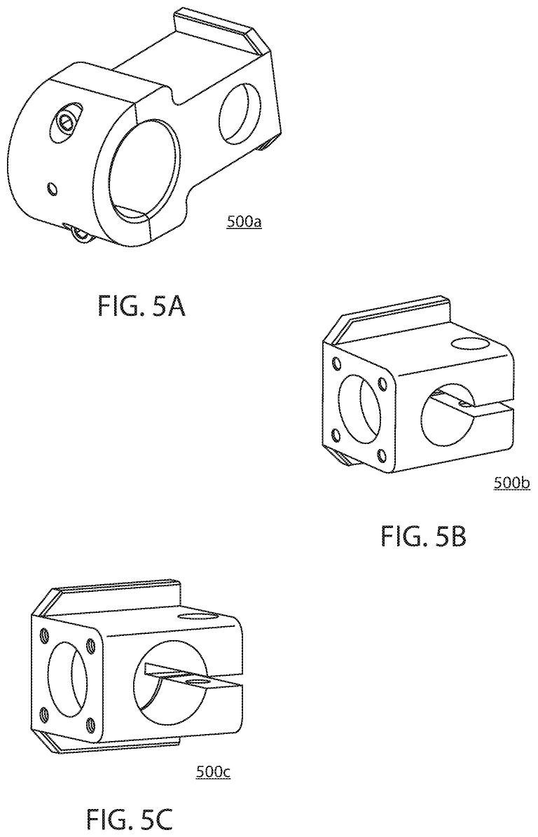

FIG. 2A, FIG. 2B and FIG. 2C are illustrations showing a perspective, assembled and exploded views respectively of an automation tooling receiver/adapter assembly used in a crossbar transfer system 200. The crossbar 201 is fitted with tooling assembly 203 e.g. where in FIG. 2B it is used for lifting the panels and moving them out of one die and into the next die e.g., in an automotive press line. Various adapters 215 (illustrated below in FIG. 4A, FIG. 4B, FIG. 4C, FIG. 4D, FIG. 5A, FIG. 5B and FIG. 5C) slide into the receiver assembly 205/207/209/221 on either side of the crossbar. Adapters can easily be changed to accommodate the different types of tooling needed. In this embodiment, the receiver/adapter assembly can be used in any application where suction cups and/or grippers are needed to pick up and move material.

FIG. 2C illustrates an exploded view of the crossbar receiver/adapter assembly. As seen in the FIG. 2C, the receiver assembly includes a receiver 207/209, a steel plate 205, and two gib supports 221. An upper spacer plate 211 and lower space plate 213 are configured between two receiver/adapter assemblies allowing a crossbar to pass through a void formed by these components. A swivel adapter 215 and a manifold 216 comprise the adapter assembly. Air fittings 217a, 217b and electrical connectors 219a, 219b are used as needed. A quick release pin 223 ensures adapter assembly is locked into place with the receiver assembly.

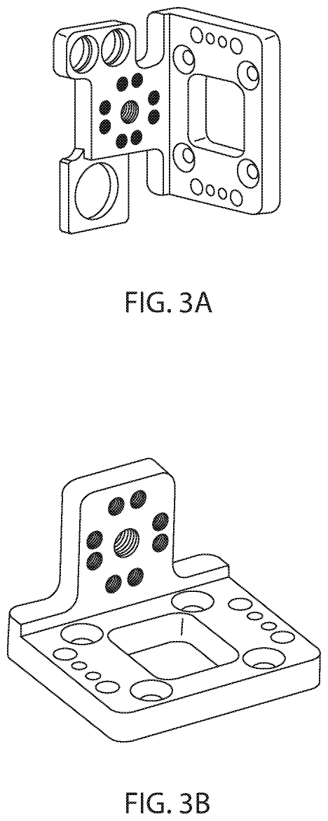

FIG. 3A and FIG. 3B are illustrations of various styles of receivers. FIG. 3A illustrates a receiver with mechanical coding, two air ports, and one electrical port. The air is used to control the vacuum or blow-off when connected to suction cups, to open and close grippers, or to control the rotation of rotators. The electric is used when part sensors are required. FIG. 3B illustrates a receiver with mechanical coding only. The mechanical coding in both receivers is used to ensure the adapter is being attached to the correct receiver. Each receiver location within a Job will have a unique mechanical code.

FIG. 4A, FIG. 4B, FIG. 4C and FIG. 4D are illustrations showing magnified views of the various styles of tooling adapters used with the receiver/adapter assembly. FIG. 4A is a simplified mount adapter. FIG. 4B is a double blank adapter, FIG. 4C is a ball mount adapter and FIG. 4D is a swivel adapter. Each of the adapters shown in FIGS. 4A, 4B, 4C and 4D work to uniquely connect a tooling implement to a receiver.

FIG. 5A, FIG. 5B and FIG. 5C are illustrations of various styles of straight tooling adapters. The adapters 500a, 500b, 500c work to handle all types of material handling end-of-arm tooling. The adapter style is dependent on the style of tooling needed for a particular application.

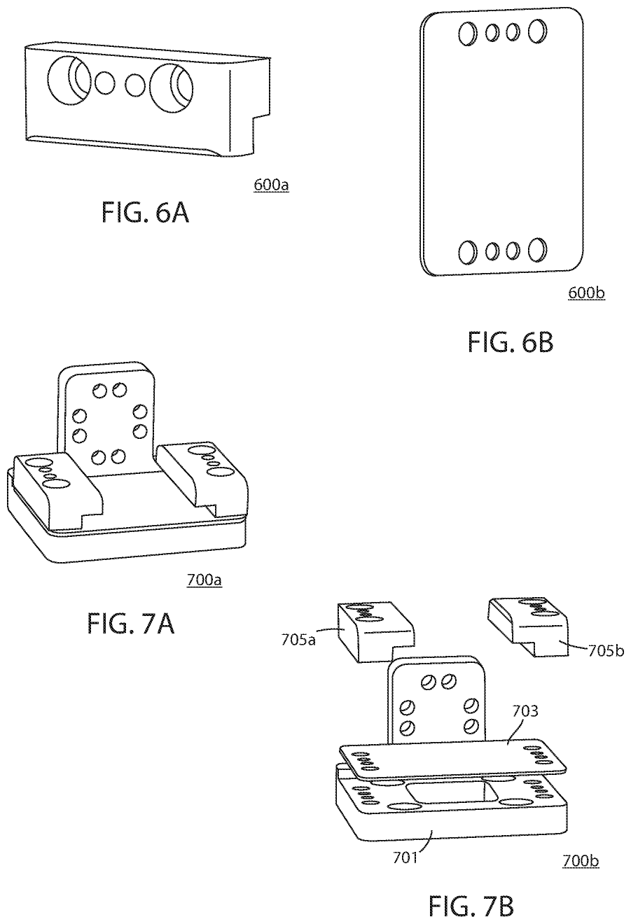

FIG. 6A and FIG. 6B are illustrations of a gib support and steel plate respectively. Two gib supports 600a are used to secure adapters to a-receiver. The steel plate 600b is attached to the receiver and is used to help reduce the wear on the receiver.

FIG. 7A and FIG. 7B are illustrations of a receiver assembly and its exploded view with no air/electric provision. As seen the assembled view 700a and exploded view 700b, the receiver assembly includes a base 701, mounting plate 703 and risers 705a, 705b.

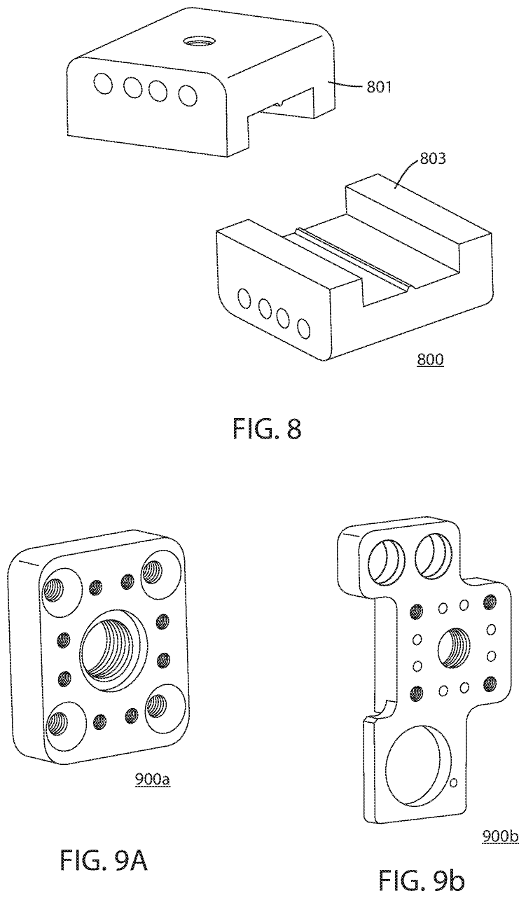

FIG. 8 is an illustration of upper and lower Verson spacer plates 800. The upper plate 801 and lower spacer plate 803 are placed above and below the Verson crossbar. A set screw is used in the upper spacer plate to keep the completed assembly from sliding on the Verson crossbar.

FIG. 9A and FIG. 9B are illustrations of various adapter manifolds. In use the adapter manifold mounts to the adapter. The adapter manifold style 900a 900b is determined by the type of receiver being used i.e., air/no air, electric/no electric.

Thus, the present invention is directed to a universal automation tooling receiver/adapter assembly that includes a receiver with mechanical coding which may include air and electric, a steel plate, and two gib supports. The adapter style is dependent on the type of tooling required and uses a manifold with mechanical coding, which may include both air and electric control lines. The receiver/adapter assembly can be used in various applications where material is being picked up and moved from point A to point B or to hold parts between operations in a press. Those skilled in the art will recognize that the use of the receiver/adapter with crossbar is only one application the receiver/adapter can be used. The receiver/adapter can also be used independently in any application that allows the receiver to be attached to tooling.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A universal automation tooling receiver/adapter assembly comprised of:
a receiver having mechanical coding including at least one air fitting, electric control line, a steel plate, and two gib supports;
an adapter body whose style is dependent on the type of tooling required and a manifold with mechanical coding and which may include air and electric; and
wherein the receiver/adapter assembly is used in applications where material is picked up and moved from a first location to second location.

2. A universal automation tooling receiver/adapter as in claim 1, wherein the receiver adapter assembly is used to hold parts between operations in a press.

3. A universal automation tooling receiver/adapter assembly comprised of:
a receiver having mechanical coding, a steel plate and at least two gib supports;
an adapter body whose style is dependent on the type of tooling required having a manifold with mechanical coding and which includes air and electric control; and
wherein the receiver/adapter assembly is used in applications where material is held in a fixed position between operations in a press.

4. A universal automation tooling receiver/adapter assembly as in claim 1, wherein the mechanical coding includes both air and electric receiver lines.

5. A universal automation tooling receiver/adapter assembly comprised of:
a receiver having mechanical coding using a plurality of control lines, a steel plate, and two gib supports;
an adapter body whose style is dependent on the type of tooling required and a manifold with mechanical coding and which may include air and electric; and
wherein the receiver/adapter assembly can be used in applications where material is being picked up and moved from a first location to second location.

6. A universal automation tooling receiver/adapter assembly as in claim 5, wherein the plurality of control lines includes at least one of air receiver line and at least one electric receiver line.

7. A universal automation tooling receiver/adapter as in claim 5, wherein the receiver adapter assembly is used to hold parts between operations in a press.
